(19) United States
(12) Patent Application Publication
(10) Pub. No.: US 2015/0254632 A1
(43) Pub. Date: Sep. 10, 2015

(54) MOBILE PAYMENT SERVICE SYSTEM AND DEVICE THEREFOR

(71) Applicant: SK PLANET CO., LTD., Seongnam-si (KR)

(72) Inventors: Chulyong SHIN, Seoul (KR); Jaehyung HUH, Seongnam-si (KR)

(21) Appl. No.: 14/538,104

(22) Filed: Nov. 11, 2014

(30) Foreign Application Priority Data
Mar. 10, 2014 (KR) 10-2014-0027781

(51) Int. Cl. G06Q 20/32; G06Q 30/02; H04W 40/24

(52) U.S. Cl. CPC G06Q 20/327; H04W 40/244; G06Q 30/0222

(57) ABSTRACT

The present invention provides a mobile payment service system and a device therefor. A terminal device is connected to a beacon device that is positioned in a store and performs Bluetooth communication, additional service information according to the mobile payment is automatically transmitted to a payment device through the beacon device, and then process result information of the additional mobile payment service processed using additional service information is received from the payment device. Therefore, it is possible to provide the additional mobile payment service for the product to be bought when mobile payment is performed. Accordingly, there is no need to perform an additional mobile payment service such as discounts/saving for a product based on users' actions and it allows users to address an inconvenience of directly presenting an alliance company card, a coupon or a gift certificate for discounts/saving for a product when payment is performed.

### CROSS-REFERENCE TO RELATED APPLICATION

This application claims priority to and the benefit of Korean Patent Application No. 10-2014-0027781 filed in the Korean Intellectual Property Office on Mar. 10, 2014, the entire contents of which are incorporated herein by reference.

### TECHNICAL FIELD

The present invention relates to a mobile payment service using Bluetooth communication, and specifically, to a mobile payment service system using Bluetooth communication in which a user who visits a store automatically transmits information in an additional service to a payment device through Bluetooth communication in the store and receives an additional mobile payment service, and a device therefor.

### BACKGROUND

Content described herein simply provides background information of the present embodiment and does not configure the related art.

Due to the development of mobile communication networks and terminal specifications, mobile communication terminals have developed from simple communication devices or information providing devices of the related art into essential possessions for modern people and continue to evolve into total entertainment devices.

Also, for mobile communication terminals, techniques for performing short range wireless communication between devices positioned in a short range are rapidly developing, and Bluetooth communication is one of such short range wireless communication techniques.

Bluetooth communication continuously evolves and a Bluetooth low energy (BLE) technique (Bluetooth 4.0) has recently been widely used for smart phones, retail geofencing, mobile payments, and the like. Such a BLE technique consumes less power than standard Bluetooth wireless connection, and has recently been mainly used for mobile payments, but mobile payments using Bluetooth communication are still in an early stage.

Recently, mobile payment services using a terminal (for example, a smart phone) have been widely used. When users buy a product in a franchise store, an alliance service card (a membership card) for saving or discounts, a gift certificate or a coupon is provided as an additional mobile payment service. In this case, users should possess a pre-issued alliance service card, a gift certificate or a coupon. In franchise stores having point of sale (POS) systems to which near field communication (NFC) tagging is connected, saving or discounts may be performed by tagging barcodes of a pre-issued alliance company card, a gift certificate or a coupon to an NFC reader connected to a POS terminal or directly presenting the card etc.

Accordingly, POS terminals obtain card information or coupon information read through NFC or card readers and perform discount/saving processes.

In the related art, in additional services provided when mobile payments are performed in this manner, product payments and discounts/saving for products are performed based on users' actions, and users should always possess a credit card for payment or an alliance company card (or a coupon) for discounts/saving and should present the card for payment, leading to inconvenience.

### PATENT LITERATURE

Korean Unexamined Patent Application Publication No. 2012-0104677, Published on Sep. 24, 2012 (Name: Location authentication Service System using WiFi AP and Bluetooth beacon)

### SUMMARY

In view of the above-described problems, the present invention provides a mobile payment service system configured to provide an additional mobile payment service for a product to be bought when mobile payment is performed, in which a terminal device is connected to a beacon device that is positioned in a store and performs Bluetooth communication, additional service information according to the mobile payment is automatically transmitted to a payment device through the beacon device, and then process result information of the additional mobile payment service processed using additional service information is received from the payment device, and a device therefor.

According to an exemplary embodiment of the present invention, there is provided a terminal device. The terminal device may include a communication unit configured to perform communication for an additional mobile payment service between a service device connected via a communication network and a beacon device that is connected through a Bluetooth communication method and positioned in a store; and a control unit configured to perform control such that a beacon signal transmitted from the beacon device positioned in the store through the communication unit is scanned to connect to the recognized beacon device, additional service information according to mobile payment for a product to be bought is searched for in conjunction with the service device through the communication unit, the found additional service information is transmitted to a payment device in the store through the beacon device, and process result information obtained by processing an additional mobile payment service using the additional service information is received from the payment device through the beacon device.

In the terminal device according to the exemplary embodiment of the present invention, an application for executing the additional mobile payment service, additional service information, and process result information of the additional mobile payment service may be stored under control of the control unit.

In the terminal device according to the exemplary embodiment of the present invention, the control unit may transmit beacon identification information of the beacon device to the service device, and receive and search for additional service information to be used in store identified using the beacon identification information from the service device.

In the terminal device according to the exemplary embodiment of the present invention, the control unit may identify alliance service information from the additional service information received from the service device, read pre-stored alliance service card information corresponding to the identified alliance service information, and add the read alliance service card information to additional service information to be transmitted to the payment device.

In the terminal device according to the exemplary embodiment of the present invention, the control unit may perform control such that beacon identification information included in the beacon signal transmitted from the beacon device is transmitted to the service device, and the store information identified using the beacon identification information is received from the service device.

In the terminal device according to the exemplary embodiment of the present invention, the control unit may identify a store in which the beacon device is positioned using the store information, search for pre-stored additional service information to be used in the identified store, and read and transmit the found additional service information to the payment device.

In the terminal device according to the exemplary embodiment of the present invention, the additional service information may include at least one of a coupon, a gift certificate, alliance service information, and alliance service card information.

According to another exemplary embodiment of the present invention, there is provided a payment device. The payment device may include a communication unit configured to perform communication for an additional mobile payment service between a service device connected via a communication network and at least one beacon device positioned in a store connected through a Bluetooth communication method; and a payment processing unit configured to perform control such that additional service information is received through the beacon device from a terminal device positioned in the store when mobile payment for a product to be bought is performed, the additional mobile payment service for the product to be bought is processed using the received additional service information, and process result information is transmitted to the terminal device through the beacon device.

In the payment device according to the exemplary embodiment of the present invention, the payment processing unit may identify a discount price of the product to be bought using at least one of a coupon, a gift certificate, and alliance card information included in the additional service information, and process payment for the product to be bought according to the identified discount price.

In the payment device according to the exemplary embodiment of the present invention, the payment processing unit may identify an alliance card for which an additional mobile payment service is received using alliance card information included in the additional service information, and apply some of the price of the product to be bought as points or mileage to the identified alliance card after a payment process of the product to be bought is performed.

According to still another exemplary embodiment of the present invention, there is provided a mobile payment service system. The mobile payment service system may include a terminal device configured to connect to a beacon device positioned in a store to be connected through a Bluetooth communication method, search for additional service information according to mobile payment for a product to be bought, transmit the found additional service information to a payment device in the store through the beacon device, and receive process result information of an additional mobile payment service from the payment device through the beacon device; and the payment device configured to connect to the beacon device through the Bluetooth communication method, receive the additional service information through the beacon device from the terminal device when mobile payment for the product to be bought is performed, process the additional mobile payment service for the product to be bought using the received additional service information, and transmit the process result information to the terminal device through the beacon device.

The mobile payment service system according to the exemplary embodiment of the present invention may further include a service device configured to connect to at least one terminal device and a payment device via a communication network, and when an information request is received from the terminal device, identify a store in which a corresponding beacon device is positioned corresponding to beacon identification information using the beacon identification information received from the terminal device, and provide additional service information related to the identified store to the terminal device.

According to the present invention, a terminal device and a payment device may perform BLE communication through a beacon device. Therefore, since the terminal device automatically transmits additional service information of a product to be bought to the payment device through the beacon device, there is no need for users to perform an action for an additional mobile payment service such as discounts/saving for a product and the additional mobile payment service may be provided simply.

Also, according to the present invention, there is no need for users to always possess additional service information such as an alliance service card, a coupon or a gift certificate for the additional mobile payment service, and it is possible to address the inconvenience of directly presenting an alliance company card, a coupon or a gift certificate for discounts/saving for a product when payment is performed.

### BRIEF DESCRIPTION OF DRAWINGS

FIG. 1 is a diagram illustrating a configuration of a mobile payment service system according to an embodiment of the present invention.

FIG. 2 is a diagram illustrating a configuration of a terminal device in the mobile payment service system of according to the embodiment of the present invention.

FIG. 3 is a diagram illustrating a configuration of a payment device in the mobile payment service system according to the embodiment of the present invention.

FIG. 4 is a diagram illustrating a configuration of a service device in the mobile payment service system according to the embodiment of the present invention.

FIG. 5 is a diagram illustrating additional mobile payment service procedures using Bluetooth communication in the mobile payment service system according to the embodiment of the present invention.

FIG. 6 is a diagram illustrating an additional mobile payment service method using Bluetooth communication in a terminal device according to an embodiment of the present invention.

FIG. 7 is a diagram illustrating an additional mobile payment service method using Bluetooth communication in a service device according to an embodiment of the present invention.

### DETAILED DESCRIPTION

Hereinafter, exemplary embodiments of the invention will be described in detail with reference to the accompanying drawings. However, detailed descriptions of well-known functions or configurations that unnecessarily obscure the gist of the invention in the following explanations and accompanying drawings will be omitted. The same reference numbers will be used throughout this specification to refer to the same or like parts.

Terms and words used in this specification and claims should not be interpreted as limited to commonly used meanings or meanings in dictionaries and should be interpreted with meanings and concepts which are consistent with the technological scope of the invention based on the principle that the inventors have appropriately defined concepts of terms in order to describe the invention in the best way. Therefore, since the embodiments described in this specification and configurations illustrated in drawings are only exemplary embodiments and do not represent the overall technological scope of the invention, it is understood that the invention covers various equivalents, modifications, and substitutions at the time of filing of this application.

First, a mobile payment service system according to an embodiment of the present invention will be described in detail with reference to the accompanying drawing.

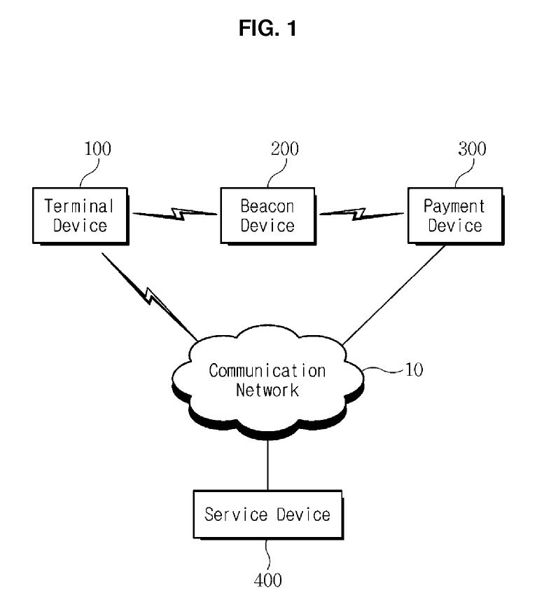

FIG. 1 is a diagram illustrating a configuration of a mobile payment service system according to an embodiment of the present invention.

As illustrated in FIG. 1, a mobile payment service system may include at least one terminal device 100, at least one beacon device 200, a payment device 300, and a service device 400, which are connected via a communication network 10.

The terminal device 100 refers to a terminal capable of transmitting and receiving various types of data via the communication network 10 according to a user's key manipulation, and may include any of a tablet PC, a laptop, a personal computer (PC), a smart phone, a personal digital assistant (PDA), a smart TV, a mobile communication terminal, and the like.

Also, the terminal device 100 is a terminal configured to perform voice and data communication using the communication network 10, and refers to a terminal including a browser configured to communicate with the service device 400 via the communication network 10, a memory configured to store a program and a protocol, a microprocessor configured to perform computation and control by executing various programs, and the like. That is, the terminal device 100 includes any terminal that can perform server-client communication with the service device 400 and execute a customized service, and broadly includes a communication computing device such as a notebook computer, a mobile communication terminal, a PDA, and the like. Meanwhile, the terminal device 100 is preferably manufactured to have a touch screen, but the present invention is not limited thereto.

Also, the terminal device 100 is a terminal capable of performing Bluetooth communication (for example, Bluetooth 4.0, that is, Bluetooth low energy, hereinafter referred to as “BLE”), that may connect to the beacon device 200 through BLE communication, and transmit or receive information on a mobile payment service and an additional mobile payment service to or from the payment device 300.

In particular, the terminal device 100 according to the embodiment of the present invention may scan a beacon signal, connect to the beacon device 200 positioned in a recognized store, search for additional service information according to mobile payment for a product to be bought, and transmit the found additional service information to the payment device 300 in the store through the beacon device 200 using a Bluetooth communication method. Also, when the payment device 300 processes the additional mobile payment service using the transmitted additional service information, the terminal device 100 may receive process result information of the additional mobile payment service from the payment device 300 through the beacon device 200.

Also, the terminal device 100 may transmit beacon identification information of the recognized beacon device 200 to the service device 400 to be connected via the communication network, request additional service information of the additional mobile payment service, and accordingly receive the found additional service information from the service device 400.

The beacon device 200 according to the embodiment of the present invention is positioned in the store, may transmit or receive information of the mobile payment service and the additional mobile payment service to or from the at least one terminal device 100 and the payment device 300 in the store through BLE communication, and broadcast a beacon signal including unique identification information (Uniq ID) to the at least one terminal device 100.

The payment device 300 according to the embodiment of the present invention is connected to the service device 400 via the communication network 10, communicates with the beacon device 200 positioned in the store through BLE communication, and therefore may transmit or receive a message for the additional mobile payment service to or from the at least one terminal device 100 in the store. Also, when additional service information is received through the beacon device 200 while mobile payment for the product to be bought is performed by the terminal device 100, the payment device 300 may process the additional mobile payment service for the product to be bought using the received additional service information, and transmit process result information to the terminal device 100 through the beacon device 200.

The service device 400 according to the embodiment of the present invention is connected to the at least one terminal device 100 and the payment device 300 in the store via the communication network 10, provides an application (or a program) for the mobile payment service and the additional mobile payment service and related information, and may receive and integrally manage payment information processed in the payment device 300 and process result information of saved points (or mileage). Also, when an information request is received from the terminal device 100, the service device 400 may identify a store in which the beacon device is positioned corresponding to beacon identification information using the beacon identification information received from the terminal device 100, search for additional service information related to the identified store, and provide the found additional service information to the terminal device 100.

In this manner, the terminal device 100, the payment device 300, and the service device 400 are connected via the communication network 10. The communication network 10 may refer to a network capable of transmitting and receiving data using an Internet protocol by various wired and/or wireless communication techniques such as an Internet network, an Intranet network, a mobile communication network, or a satellite communication network. Also, the communication network 10 is combined with the service device 400 and stores computing resources such as hardware or software. The communication network 10 broadly includes a closed network such as a local area network (LAN) and a wide area network (WAN), an open network such as the Internet, a network such as code division multiple access (CDMA), Wideband Code Division Multiple Access (WCDMA), Global System for Mobile Communications (GSM), Long Term Evolution (LTE), and Evolved Packet Core (EPC), and a next generation network and computing network to be implemented.

In the mobile payment service system configured in this manner, a configuration of a terminal device according to an embodiment of the present invention will be described below in detail with reference to the accompanying drawing.

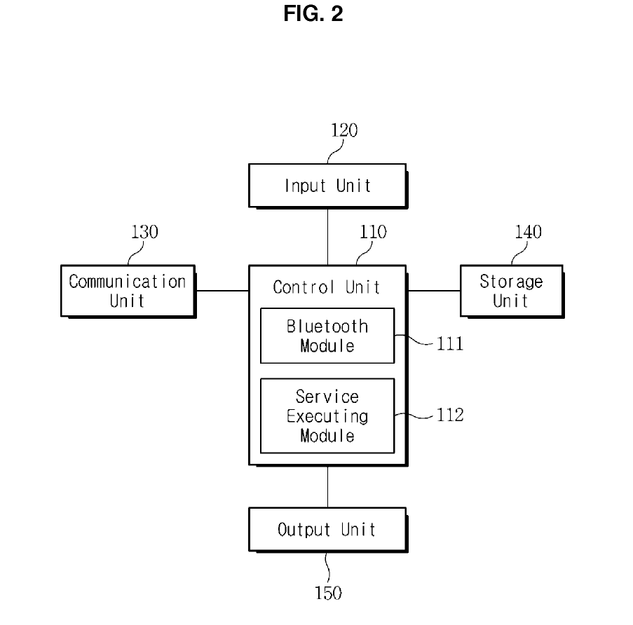

FIG. 2 is a diagram illustrating a configuration of a terminal device in the mobile payment service system of according to the embodiment of the present invention.

As illustrated in FIG. 2, the terminal device 100 may include a control unit 110, an input unit 120, a communication unit 130, a storage unit 140, and an output unit 150.

The control unit 110 performs overall control of the terminal device 100, and particularly, performs control for processing the mobile payment service and the additional mobile payment service according to mobile payment, and may perform control for Bluetooth communication with the beacon device 200 in the store that the user has visited by scanning a beacon signal. For this purpose, the control unit 110 may include a Bluetooth module 111 and a service executing module 112.

The Bluetooth module 111 according to the embodiment of the present invention may control BLE communication with the beacon device 200, and perform a procedure of connecting or disconnecting to or from the beacon device 200 such that information related to the mobile payment service and the additional mobile payment service may be transmitted or received through BLE communication. Also, the Bluetooth module 111 may scan a beacon signal broadcast from the beacon device 200 and deliver the scanned beacon signal to the service executing module 112. Also, the Bluetooth module 111 performs control such that the beacon device 200 may be recognized by identifying identification information included in the scanned beacon signal and may perform a procedure of connecting to the recognized beacon device 200.

The service executing module 112 according to the embodiment of the present invention may receive and install an application for the mobile payment service and the additional mobile payment service from the service device 400, execute the installed application, and therefore execute the additional mobile payment service for the product to be bought when payment is performed.

Also, the service executing module 112 may recognize the beacon device 200 through beacon identification information included in the beacon signal received from the Bluetooth module 111, and when a connection to the recognized beacon device 200 is performed, search for additional service information according to mobile payment for the product to be bought, and perform control such that the found additional service information is transmitted to the payment device 300 in the store through the beacon device 200.

For this purpose, as an example, the service executing module 112 may transmit beacon identification information of the beacon device 200 to the service device 400, and receive additional service information to be used in the store identified using beacon identification information from the service device 400. Here, the service executing module 112 may receive additional service information including a coupon, a gift certificate, and alliance service information to be used in the store from the service device 400. Accordingly, when the coupon, the gift certificate, or the like is received, the service executing module 112 may add at least one of the received coupon and gift certificate to additional service information to be applied to the product to be bought and automatically transmit the information to the payment device 300 through the beacon device 200. Also, when alliance service information is received, the service executing module 112 may read pre-stored alliance service card information corresponding to alliance service information or receive alliance service card information (such as a card number and card recognition information) managed by a wallet platform (not illustrated) or the service device 400. This read or received alliance service card information may be added to additional service information to be transmitted to the payment device 300 and automatically transmitted to the payment device 300 through the beacon device 200.

As another example, the service executing module 112 may perform control such that beacon identification information included in the beacon signal transmitted from the beacon device 200 is transmitted to the service device 400 and store information identified using beacon identification information is received from the service device 400.

Also, the service executing module 112 identifies the store in which the beacon device 200 is positioned using store information (for example, information on a store name, a phone number, and an alliance service (a franchise)), and searches for pre-stored additional service information to be used in the identified store. In this case, in order to search for additional service information, the service executing module 112 may search for a gift certificate, a coupon, alliance card information, and the like that may be used for an alliance service corresponding to the received store information. Here, the pre-stored additional service information, for example, an alliance store name, an alliance service, a usage instruction, or the like to be used may be stored in the gift certificate as a tag. Therefore, the service executing module 112 may match store information in which information tagged to the gift certificate is received and read a corresponding gift certificate. When store information includes alliance service information, the service executing module 112 may read at least one of the pre-stored gift certificate, the coupon, and the alliance card information corresponding to the received alliance service information.

Then, the service executing module 112 may add at least one of the read gift certificate, coupon, and alliance card information to additional service information and automatically transmit the information to the payment device 300.

Also, the service executing module 112 may perform control such that process result information of the additional mobile payment service processed using the transmitted additional service information is received from the payment device 300 through the beacon device 200 and the received process result information is stored and output.

The input unit 120 may generate a user input signal corresponding to a user request or information according to the user's manipulation, and may be implemented by currently available input devices or input devices to be commercialized. Examples of the input unit may include general input devices such as a keyboard, a mouse, a joystick, a touch screen, and a touch pad, and gesture input devices in which the user's motion is detected and a specific input signal is generated. In particular, the input unit 120 according to the embodiment of the present invention may generate a Bluetooth communication executing (Bluetooth On) input signal, an application executing input signal for mobile payment and an additional mobile payment service and a user manipulation input signal.

The communication unit 130 may communicate with the service device 400 via the communication network 10, and transmit and receive messages related to a customized service using a beacon signal. The communication unit 130 may transmit and receive data through various communication methods in addition to a wired method and a wireless method. Further, the communication unit 130 may transmit and receive data using at least one communication method. For this purpose, the communication unit 130 may include a plurality of communication modules configured to transmit and receive data according to different communication methods. In particular, the communication unit 130 according to the embodiment of the present invention may transmit and receive related messages for performing BLE communication with the beacon device 200, and transmit or receive additional service information related to the additional mobile payment service such as discounts/saving to or from the payment device 300 through the beacon device 200. Also, the communication unit 130 may transmit an information request message including beacon identification information of the recognized beacon device 200 to the service device 400, and receive an information request response message including additional service information such as the found coupon, gift certificate, and alliance service information from the service device 400 using beacon identification information.

The storage unit 140 stores information necessary for operating the terminal device 100, and particularly, the storage unit 140 according to the embodiment of the present invention may store scanned beacon signals, pre-stored additional service information (such as a coupon, a gift certificate, alliance service card information, and alliance service information), process result information, and the like. Also, the storage unit 140 may store an application for the mobile payment service and the additional mobile payment service received from the service device 400. The storage unit 140 includes magnetic media such as a hard disk, a floppy disk, and a magnetic tape, optical media such as a compact disk read only memory (CD-ROM) and a digital video disk (DVD), magneto-optical media such as a floptical disk, a ROM, a random access memory (RAM), and a flash memory.

Also, the storage unit 140 stores an application necessary for operating functions according to embodiments of the present invention, a screen image to be output to a display unit of the output unit 150, and the like. Also, when the display unit is configured as a touch screen, the storage unit 140 may store a key map, a menu map, or the like for operating the touch screen. Here, the key map and the menu map may have various forms. The storage unit 140 may store an operating system (OS) for booting the terminal device 100 and operating the above-described components, and applications for supporting various user functions, for example, a user function for supporting a call function of the terminal device 100, an MP3 user function for reproducing other sound sources, an image output function for reproducing an image and the like, and a video reproducing function.

The output unit 150 is a unit configured such that the user can recognize an operation result or a state of the terminal device 100, and may include, for example, a display unit configured to perform visual output through a screen or a speaker configured to output an audible sound. In particular, in the terminal device 100 according to the embodiment of the present invention, a screen related to the mobile payment service and the additional mobile payment service may be displayed and the found additional service information and process result information may be displayed on the screen. Also, the output unit 150 may output a screen for manipulating ON/OFF of BLE communication.

Next, a configuration of a payment device according to an embodiment of the present invention in the mobile payment service system will be described below in detail with reference to the accompanying drawing.

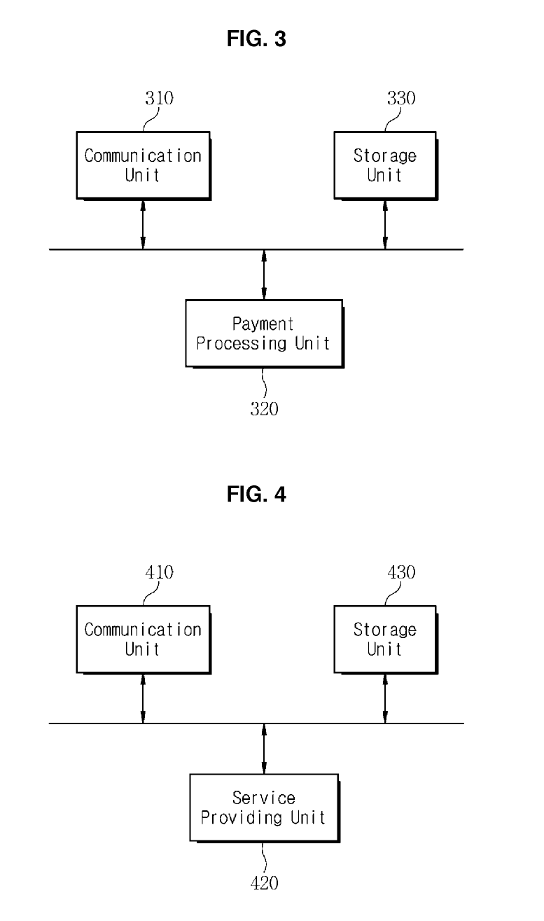

FIG. 3 is a diagram illustrating a configuration of a payment device in the mobile payment service system according to the embodiment of the present invention.

As illustrated in FIG. 3, the payment device 300 may include a communication unit 310, a payment processing unit 320, and a storage unit 330.

The communication unit 310 according to the embodiment of the present invention may perform Bluetooth communication with the at least one terminal device 100 using a BLE communication method, and transmit and receive messages for the mobile payment service and the additional mobile payment service. In particular, the communication unit 310 may receive additional service information transmitted from the terminal device 100 through the beacon device 200 and transmit process result information of the additional mobile payment service process to the terminal device 100 through the beacon device 200. Here, the additional service information may include at least one of a coupon, a gift certificate, alliance service information, and alliance service card information.

The payment processing unit 320 may process the additional mobile payment service for the product to be bought using additional service information received from the terminal device 100 when mobile payment for the product to be bought is performed. In this case, the payment processing unit 320 may identify a discount price of the product to be bought using at least one of the coupon, the gift certificate, and the alliance card information included in the additional service information and process payment for the product to be bought according to the identified discount price. Also, the payment processing unit 320 performs a certification procedure of an alliance card for which the additional mobile payment service is received using alliance card information included in the additional service information, and after payment for the product to be bought is processed, may apply some of the price of the product to be bought as points or mileage to the certified alliance card. Therefore, the payment processing unit 320 transmits the saved points or mileage to the service device 400, and therefore the service device 400 may integrally manage the saving point or mileage.

Also, the payment processing unit 320 requests certification of the received additional service information from a certification server (not illustrated) or the service device 400, and when certification is successful, may process the additional mobile payment service such as discounts/saving for the product to be bought using the additional service information.

The storage unit 330 may store related information for providing the mobile payment service and the additional mobile payment service. Specifically, the storage unit 330 may store the additional service information, process result information of the additional mobile payment service, payment information, bought product information, user information, and the like from the terminal device 100. The storage unit 330 includes magnetic media such as a hard disk, a floppy disk, and a magnetic tape, optical media such as a compact disk read only memory (CD-ROM) and a digital video disk (DVD), magneto-optical media such as a floptical disk, a ROM, a random access memory (RAM), and a flash memory.

Next, a configuration of a service device according to an embodiment of the present invention in the mobile payment service system will be described below in detail with reference to the accompanying drawing.

FIG. 4 is a diagram illustrating a configuration of a service device in the mobile payment service system according to the embodiment of the present invention.

As illustrated in FIG. 4, the service device 400 may include a communication unit 410, a service providing unit 420, and a storage unit 430.

The communication unit 410 according to the embodiment of the present invention may perform communication with the at least one terminal device 100 and the payment device via the communication network 10, and transmit and receive messages related to the mobile payment service and the additional mobile payment service. The communication unit 410 may collect traffic information through various communication methods in addition to a wired method and a wireless method, and communicate with the mobile terminal device 100 via a mobile communication network using the wireless method. Further, the communication unit 410 may transmit and receive data using at least one communication method. For this purpose, the communication unit 410 may include a plurality of communication modules configured to transmit and receive data according to different communication methods. In particular, the communication unit 410 may receive an information request message from the terminal device 100, and transmit an information request response message including the additional service information found in the service providing unit 420 to the terminal device 100.

The service providing unit 420 is functionally connected to the communication unit 410, and when the information request message including beacon identification information is received from the terminal device 100, identifies a store in which the beacon device 200 is positioned corresponding to the received beacon identification information, and may provide additional service information related to the identified store to the terminal device 100.

Also, the service providing unit 420 may receive information on the saved points or mileage of the product to be bought according to an additional mobile payment service process of the product to be bought from the payment device 300, and integrally manage information on the received points or mileage.

Also, when the payment device 300 requests approval of additional service information, the service providing unit 420 may perform an approval process of the additional service information received from the payment device 300 and transmit approval result information to the payment device 300 or the terminal device 100.

The storage unit 430 may store related information for providing the mobile payment service and the additional mobile payment service. Specifically, the storage unit 430 may store the found additional service information according to the terminal device 100, process result information of the additional mobile payment service received from the payment device 300, and the like. The storage unit 430 includes magnetic media such as a hard disk, a floppy disk, and a magnetic tape, optical media such as a compact disk read only memory (CD-ROM) and a digital video disk (DVD), magneto-optical media such as a floptical disk, a ROM, a random access memory (RAM), and a flash memory.

Next, in the mobile payment service system configured in this manner, a method of providing an additional mobile payment service using Bluetooth communication will be described in detail with reference to the accompanying drawings. First, procedures for an additional mobile payment service using Bluetooth communication in the mobile payment service system according to the embodiment of the present invention will be described.

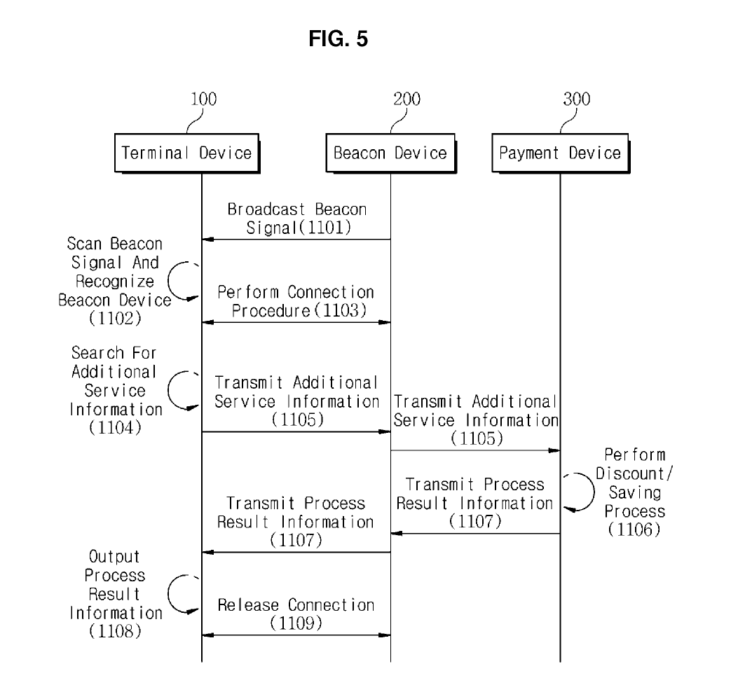

FIG. 5 is a diagram illustrating additional mobile payment service procedures using Bluetooth communication in the mobile payment service system according to the embodiment of the present invention.

As illustrated in FIG. 5, in operation 1101, the beacon device 200 broadcasts a beacon signal.

The terminal device 100 receives and installs an application for the mobile payment service and the additional mobile payment service from the service device 400, and executes the mobile payment service. In this case, when the user enters a specific store, in operation 1102, the terminal device 100 scans a beacon signal transmitted from the beacon device 200 positioned in the visited store, identifies beacon identification information included in the scanned beacon signal, and recognizes the beacon device 200 in the store.

Then, in the next operation 1103, the terminal device 100 performs a connection procedure for performing BLE communication with the recognized beacon device 200 and is connected to the recognized beacon device 200. Accordingly, the terminal device 100 performs a mobile payment service for paying for a product to be bought by the user, and executes the additional mobile payment service such as discounts/saving for the product to be bought.

Therefore, in operation 1104, the terminal device 100 searches for additional service information (for example, a coupon, a gift certificate, alliance service card information, and alliance service information) of the additional mobile payment service for the product to be bought.

Then, in the next operation 1105, for example, at least one piece of additional service information among the found coupon, gift certificate, alliance service card information, and alliance service information is transmitted to the beacon device 200. Therefore, the beacon device 200 transmits the received additional service information to the payment device 300.

Then, in operation 1106, the payment device 300 performs an additional mobile payment service process such as discounts/saving using the received additional service information. In operation 1107, process result information according to the additional mobile payment service process is transmitted to the terminal device 100 through the beacon device 200.

Accordingly, in operation 1108, the terminal device 100 outputs the received process result information to an executing screen. Then, in operation 1109, when there are no more products to be bought or the terminal device 100 is a predetermined distance or more from the store, a connection with the beacon device 200 is released.

According to the procedures for the additional mobile payment service as described above, a detailed method of an additional mobile payment service in a terminal device will be described below.

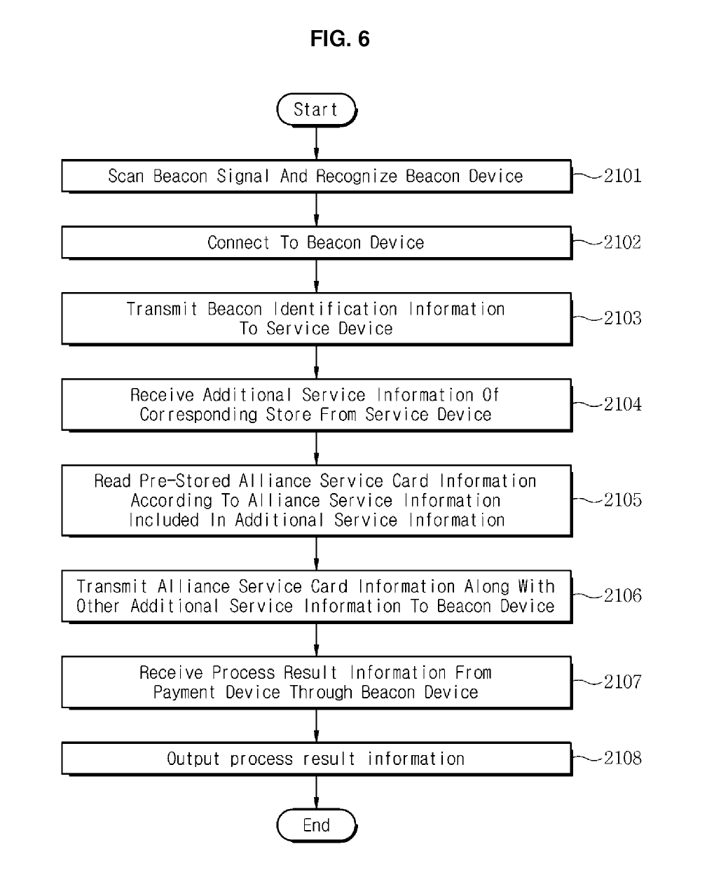

FIG. 6 is a diagram illustrating an additional mobile payment service method using Bluetooth communication in a terminal device according to an embodiment of the present invention.

As illustrated in FIG. 6, first, the terminal device 100 receives and installs an application for the mobile payment service and the additional mobile payment service from the service device 400, and performs the mobile payment service by executing the application according to the user's request. In this case, in operation 2101, the terminal device 100 scans a beacon signal generated from the at least one beacon device 200 positioned in an adjacent region, and recognizes the beacon device 200 through beacon identification information included in the scanned beacon signal.

Then, in the next operation 2102, the terminal device 100 performs a connection procedure for performing BLE communication with the recognized beacon device 200 and is connected to the recognized beacon device 200. Accordingly, the terminal device 100 performs a mobile payment service for paying for a product to be bought by the user, and executes the additional mobile payment service such as discounts/saving for the product to be bought when mobile payment is performed.

For this purpose, in operation 2103, the terminal device 100 transmits an information request message including beacon identification information to the service device 400. Therefore, the service device 400 identifies a store in which the beacon device 200 is positioned using the beacon identification information, searches for additional service information such as a coupon and a gift certificate related to the identified store and information (franchise information) of an alliance service to which the store subscribes, and provides the found additional service information to the terminal device 100 in response to the information request. In this case, the service device 400 may also provide store information to the terminal device 100 according to an information request. In this case, the terminal device 100 identifies the store in which the beacon device 200 is positioned using the store information and searches for pre-stored additional service information to be used in the identified store.

Therefore, in operation 2104, the terminal device 100 may receive additional service information (a coupon, a gift certificate, alliance service information, and the like) of a corresponding store from the service device 400.

Then, in the next operation 2105, the terminal device 100 identifies alliance service information included in the received additional service information, and reads pre-stored alliance service card information corresponding to the alliance service information. Also, in operation 2106, the read alliance service card information is transmitted to the payment device 300 through the beacon device 200 along with the received other additional service information.

Then, in operation 2107, the terminal device 100 receives process result information (discount/saving result information) according to the additional mobile payment service process from the payment device 300 using additional service information. In operation 2108, the received process result information is stored and output.

Next, an additional mobile payment service method using Bluetooth communication in a service device according to an embodiment of the present invention will be described below.

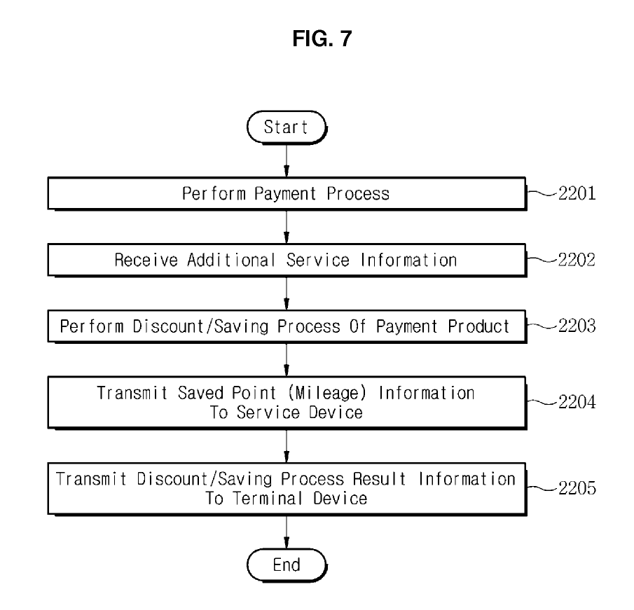

FIG. 7 is a diagram illustrating an additional mobile payment service method using Bluetooth communication in a service device according to an embodiment of the present invention.

As illustrated in FIG. 7, in operation 2201, the payment device 300 performs a payment process of the product to be bought. Then, in operation 2202, when additional service information such as a coupon, a gift certificate, or alliance service card information is received from the terminal device 100, the payment device 300 processes the additional mobile payment service such as discounts/saving for the product to be bought in operation 2203.

Then, in the next operation 2204, the payment device 300 transmits point (or mileage) information applied to the product to be bought to the service device 400. Therefore, the service device 400 integrally manages the received saved point (or mileage) information for each alliance service for the user.

Then, in the next operation 2205, the payment device 300 transmits process result information according to an additional mobile payment service process to the terminal device 100.

Meanwhile, a program instruction to be recorded may be specially designed and prepared for the invention or may be an available well-known instruction for those skilled in the field of computer software. The recording media includes a hardware device that is specially made to store and perform the program instruction, for example, magnetic media such as a hard disk, a floppy disk and a magnetic tape, optical media such as a compact disk read only memory (CD-ROM) or a digital video disk (DVD), magneto-optical media such as a floptical disk, a ROM, a random access memory (RAM), or a flash memory. Examples of the program instruction may include a machine code generated by a compiler and a high-level language code that can be executed in a computer using an interpreter. Such a hardware device may be configured as at least one software module in order to perform operations of the invention and vice versa.

Also, a computer program (also referred to as a program, software, a software application, a script, or a code) that is provided in a device according to the invention and executes the method according to the invention may be implemented by any type of programming language that includes a compiled or interpreted language, or a prior or procedural language, and may be deployed as any type such as an independent program, a module, a component, or a subroutine, or including another unit appropriate for a computer environment. The computer program does not necessarily correspond to files of a file system. The program may be stored in a unit file provided for a requested program, in multiple interacting files (for example, files that store at least one module, a sub program, and some of a code), or in some of a file that includes another program or data (for example, at least one script stored in a markup language document). The computer program is located in one site or distributed over many sites so that it is deployed to be executed in mutually accessed multiple computers via a communication network or in a single computer.

The embodiments disclosed in this specification and drawings are only examples to help understanding of the invention and the invention is not limited thereto. It is apparent to those skilled in the art that various modifications based on the technological scope of the invention in addition to the embodiments disclosed herein can be made.

Also, while this specification includes details of a plurality of specific implementations, these should not be understood as limitations of any invention or the scope to be claimed, but should be understood as descriptions of features that can be specific to specific embodiments of the specific invention. Specific features described herein may also be implemented by being combined in a single embodiment in the context of an individual embodiment. On the other hand, various features described in the context of a single embodiment may be implemented individually or in appropriate sub-combinations in a plurality of embodiments. While features operate as specific combinations and are described and claimed initially as such, at least one feature may be excluded from claimed combinations in some cases, and the claimed combinations may be changed to sub-combinations or modifications of the sub-combinations.

Similarly, while drawings illustrate operations in a particular order, this does not mean that these operations should be performed in the illustrated specific order or sequence or that all illustrated operations should be performed in order to obtain a desired result. In a particular case, multi-tasking and parallel processing may be advantageous. Separation of various system components in the above embodiment does not mean that such separation is required for all embodiments. In general, described program components and systems may be integrated in a single software product or may be packed in multiple software products.

The present invention relates to a mobile payment service system and a device therefor. A terminal device and a payment device may perform BLE communication through a beacon device. Therefore, since the terminal device automatically transmits additional service information of a product to be bought to the payment device through the beacon device, there is no need to perform an additional mobile payment service such as discounts/saving for a product based on users' actions and the additional mobile payment service may be simply provided.

Also, according to the present invention, users have no need to always possess additional service information such as an alliance service card, a coupon or a gift certificate for the additional mobile payment service, and it is possible to address an inconvenience of directly presenting an alliance company card, a coupon or a gift certificate for discounts/saving for a product when payment is performed.

In addition, the present invention has a high probability of commercialization or sale, is clearly implementable in reality, and thus has industrial applicability.

What is claimed is:

1. A terminal device, comprising:
a communication unit configured to perform communication for an additional mobile payment service between a service device connected via a communication network and a beacon device that is connected through a Bluetooth communication method and positioned in a store; and
a control unit configured to perform control such that a beacon signal transmitted from the beacon device positioned in the store through the communication unit is scanned to connect to the recognized beacon device, additional service information according to mobile payment for a product to be bought is searched for in conjunction with the service device through the communication unit, the found additional service information is transmitted to a payment device in the store through the beacon device, and process result information obtained by processing an additional mobile payment service using the additional service information is received from the payment device through the beacon device.

2. The terminal device of claim 1, further comprising
a storage unit configured to store an application for executing the additional mobile payment service, the additional service information, and process result information of the additional mobile payment service under control of the control unit.

3. The terminal device of claim 1,
wherein the control unit transmits beacon identification information of the beacon device to the service device, and receives and searches for additional service information to be used in the store identified using the beacon identification information from the service device.

4. The terminal device of claim 3,
wherein the control unit performs control such that alliance service information is identified from the additional service information received from the service device, pre-stored alliance service card information corresponding to the identified alliance service information is read, and the read alliance service card information is added to additional service information to be transmitted to the payment device and is automatically transmitted to the payment device.

5. The terminal device of claim 1,
wherein the control unit performs control such that beacon identification information included in the beacon signal transmitted from the beacon device is transmitted to the service device, and store information identified using the beacon identification information is received from the service device.

6. The terminal device of claim 5,
wherein the control unit performs control such that a store in which the beacon device is positioned is identified using the store information, pre-stored additional service information to be used in the identified store is searched for, and the found additional service information is read and transmitted to the payment device.

7. The terminal device of claim 1,
wherein the additional service information includes at least one of a coupon, a gift certificate, alliance service information, and alliance service card information.

8. A payment device, comprising:
a communication unit configured to perform communication for an additional mobile payment service between a service device connected via a communication network and at least one beacon device positioned in a store connected through a Bluetooth communication method; and
a payment processing unit configured to perform control such that additional service information is received through the beacon device from a terminal device positioned in the store when mobile payment for a product to be bought is performed, the additional mobile payment service for the product to be bought is processed using the received additional service information, and process result information is transmitted to the terminal device through the beacon device.

9. The payment device of claim 8,
wherein the payment processing unit identifies a discount price of the product to be bought using at least one of a coupon, a gift certificate, and alliance card information included in the additional service information, and processes payment for the product to be bought according to the identified discount price.

10. The payment device of claim 8,
wherein the payment processing unit identifies an alliance card for which an additional mobile payment service is received using alliance card information included in the additional service information, and applies some of the price of the product to be bought as points or mileage to the identified alliance card after a payment process of the product to be bought is performed.

11. A mobile payment service system, comprising:
a terminal device configured to connect to a beacon device positioned in a store to be connected through a Bluetooth communication method, search for additional service information according to mobile payment for a product to be bought, transmit the found additional service information to a payment device in the store through the beacon device, and receive process result information of an additional mobile payment service from the payment device through the beacon device; and
the payment device configured to connect to the beacon device through the Bluetooth communication method, receive the additional service information through the beacon device from the terminal device when mobile payment for the product to be bought is performed, process the additional mobile payment service for the product to be bought using the received additional service information, and transmit the process result information to the terminal device through the beacon device.

12. The mobile payment service system of claim 11, further comprising
a service device configured to connect to at least one terminal device and the payment device via a communication network, and when an information request is received from the terminal device, identify a store in which a corresponding beacon device is positioned corresponding to beacon identification information using the beacon identification information received from the terminal device, and provide additional service information related to the identified store to the terminal device.
